(19) United States
(12) Patent Application Publication
(10) Pub. No.: US 2017/0333933 A1
(43) Pub. Date: Nov. 23, 2017

(54) METHODS AND APPARATUS FOR SPRINKLER HEAD PROTECTION

(71) Applicant: Alberto Lagos, Fayetteville, NC (US)

(72) Inventor: Alberto Lagos, Fayetteville, NC (US)

(21) Appl. No.: 15/588,852

(22) Filed: May 8, 2017

Related U.S. Application Data
(60) Provisional application No. 62/337,995, filed on May 18, 2016.

(51) Int. Cl. B05B 15/00; A01G 25/00

(52) U.S. Cl. CPC B05B 15/001; A01G 25/00

(57) ABSTRACT

A sprinkler head protector and a sprinkler head protector and sprinkler head combination are described. A flexible nonwoven geotextile sprinkler head protector has an opening therein sized to allow said protector to be pulled by hand over a slightly larger outer dimension of a sprinkler head. Once installed, the outer portion of the sprinkler head protector is trapped under the outer edge of the sprinkler head. Among its several purposes, the sprinkler head protector blocks vegetation from overgrowing or growing into the sprinkler head, prevents or reduces vegetation growth in the immediate vicinity of the sprinkler head, provides physical support to the sprinkler head, helping it maintain its proper vertical alignment, and provides a physical barrier to stop sand and dirt from entering the interior of the sprinkler head.

The present application claims the benefit of U.S. Provisional Patent Application Ser. No. 62/337,995 filed on May 18, 2016 entitled “Methods and Apparatus for Sprinkler Head Protection”, the disclosure of which is hereby incorporated by reference in its entirety.

### FIELD OF THE INVENTION

The present invention relates generally to improvements to irrigation systems, such as those employed by individuals, golf courses, municipalities, and the like. More particularly, the present invention relates to improved sprinkler head protectors and sprinkler head protection combinations as addressed in further detail herein.

### BACKGROUND OF THE INVENTION

Automatic irrigation systems for watering lawns and the like are common. The sprinkler heads of such systems are susceptible to a wide variety of problems requiring costly maintenance or resulting in costly water waste. Exemplary problems including vegetation overgrowing sprinkler heads, grass growing into sprinkler heads, homeowners or others responsible for a sprinkler system applying weed killers to address vegetation overgrowth resulting in erosion, sand overlying the sprinkler head, sand passing into the sprinkler, and the like. Additionally, using heavy mowing equipment or walking on a sprinkler head may result in breakage, misalignment or the like, and misalignment is particularly likely where leakage or erosion around the sprinkler head reduces the support for the sprinkler head.

### SUMMARY OF THE INVENTION

Among its several aspects, the present invention recognizes that an easy to install, low cost, and environmentally friendly sprinkler protector is highly advantageous. To such ends, the present invention provides a sprinkler head protector comprising a flexible mat having a cutout smaller and shaped similarly to an outermost dimension of a corresponding sprinkler head. The flexible mat is sufficiently stretchable that it can be pulled by hand over the corresponding sprinkler head whereby an inner edge of the flexible mat is trapped under an outer edge of the corresponding sprinkler head.

A further aspect of the present invention addresses a method of protecting a sprinkler head having an outer perimeter and installed in a lawn, the method comprising: aligning a portion of a flexible inner perimeter of a similarly shaped cutout in a sprinkler head protector; pulling an inner edge of said portion underneath a portion of an outer edge of the outer perimeter of the sprinkler head; pulling a remainder of the flexible inner perimeter under a remainder of the outer edge of the outer perimeter of the sprinkler trapping the inner edge of the sprinkler head protector beneath the outer edge of the outer perimeter of the sprinkler head, and flattening the sprinkler head protector on the lawn.

According to another aspect of the invention, a sprinkler head protector and sprinkler head combination comprises a sprinkler head having an outermost dimension; a flexible mat having a cutout smaller and shaped similarly to the outermost dimension of the sprinkler head; the flexible mat being sufficiently stretchable that it can be pulled by hand over the corresponding sprinkler head; and the flexible mat having an inner edge trapped under an outer edge of the corresponding sprinkler head.

A more complete understanding of the present invention, as well as further features and advantages of the invention, will be apparent from the following Detailed Description and the accompanying drawings.

### BRIEF DESCRIPTION OF THE DRAWINGS

FIG. 1 shows a sprinkler head protector in accordance with a first embodiment of the invention;

FIG. 2 shows the sprinkler head protector of FIG. 1 partially installed on a first sprinkler head;

FIG. 3 shows the sprinkler head protector of FIG. 1 fully installed;

FIG. 4 shows the sprinkler head protector of FIG. 1 in combination with a sprinkler head and illustrates how the combination is easily visible and thus readily avoidable by someone mowing or walking across the lawn;

FIG. 5 shows the sprinkler head protector and sprinkler head combination after a recent mowing illustrating how the sprinkler head protector keeps its position and conforms to the desired shape even after mowing;

FIG. 6 shows the sprinkler head protector and sprinkler head combination with the sprinkler head open illustrating how the sprinkler head protector keeps the interior of the sprinkler head free of debris; and

FIG. 7 shows a method of utilizing the sprinkler head protector of FIG. 1;

FIG. 8 shows a sprinkler head protector and sprinkler head combination in accordance with a second embodiment of the invention; and

FIG. 9 shows a larger view of the sprinkler head protector of FIG. 8.

### DETAILED DESCRIPTION

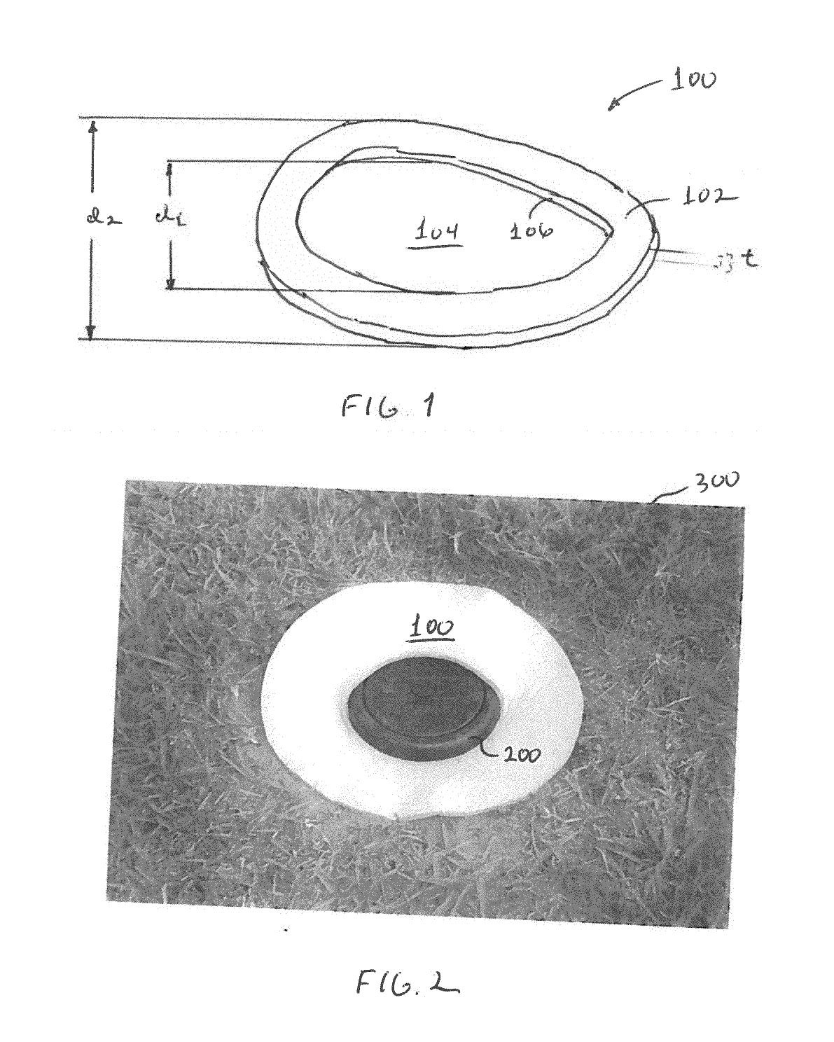

FIG. 1 shows a sprinkler head protector 100 in accordance with one embodiment of the present invention. Sprinkler head protector 100 comprises a circular band of material with a top surface 102, a bottom surface (not shown), a circular cutout or opening 104, an inner diameter, d₁, an outer diameter, d₂, and a thickness, t. It will be recognized that the dimensions, d₁, d₂ and t will vary based upon the sprinkler head with which the sprinkler head protector 100 is to be used. For example, with a sprinkler head having a circular top with an outer diameter of 5 inches, d₁ is preferably 9 inches, d₂ is preferably 4⅜ inches and t is preferably ¼ inch. A presently preferred material for the sprinkler head protector 100 is a water permeable nonwoven geotextile material, such as the geotextile non-woven fabric manufactured by FOCUS SALES & MARKETING GROUP, LLC.

As seen in FIG. 2, the sprinkler head protector 100 is partially installed over a sprinkler head 200. A bottom surface of the sprinkler head protector 100 is supported by the ground in which the sprinkler head 200 is installed and the sprinkler head protector 100 and sprinkler head 200 combination is surrounded by grass 300. In FIG. 2, a bottom edge of sprinkler head 200 has been pulled through opening 104. An upper edge of the sprinkler head 200 is still below the bottom surface of sprinkler head protector 100 as it has not been pulled fully onto the sprinkler head 200. The presently preferred nonwoven geotextile has enough flexibility and elasticity that it will stretch sufficiently to allow its installation even though the inner diameter, d₁, of sprinkler head protector 100 is smaller than a largest outer diameter of the sprinkler head 200. This arrangement is highly advantageous in that it both 1) makes installation very easy and 2) results in an inner edge 106 and a portion of top surface 102 being trapped under a bottom edge of a head piece of the sprinkler head 200 holding the sprinkler head protector 100 in place. The flexibility of the sprinkler head protector 100 allows easy installation by hand without requiring any special tool or tools.

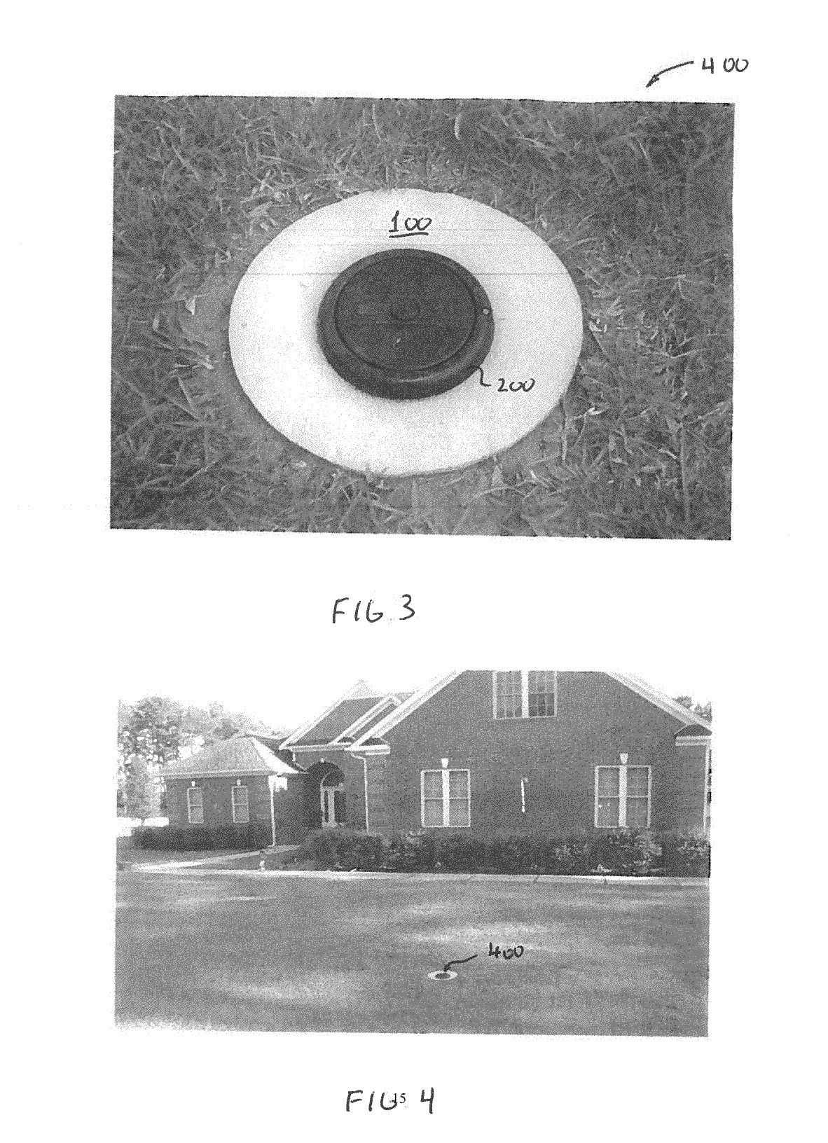

FIG. 3 shows the sprinkler head protector 100 fully installed on the sprinkler head 200 to form a sprinkler head protector and sprinkler head combination 400. As shown in FIG. 3, the sprinkler head protector 100 provides a physical barrier to prevent migration of foreign matter towards the sprinkler head 200 thus reducing the opportunity for entry of foreign matter inside the sprinkler head 200. The sprinkler head protector 100 also helps maintain the sprinkler head 200 in the proper physical alignment by providing physical support beneath the outer portion of the underrun of the sprinkler head 200.

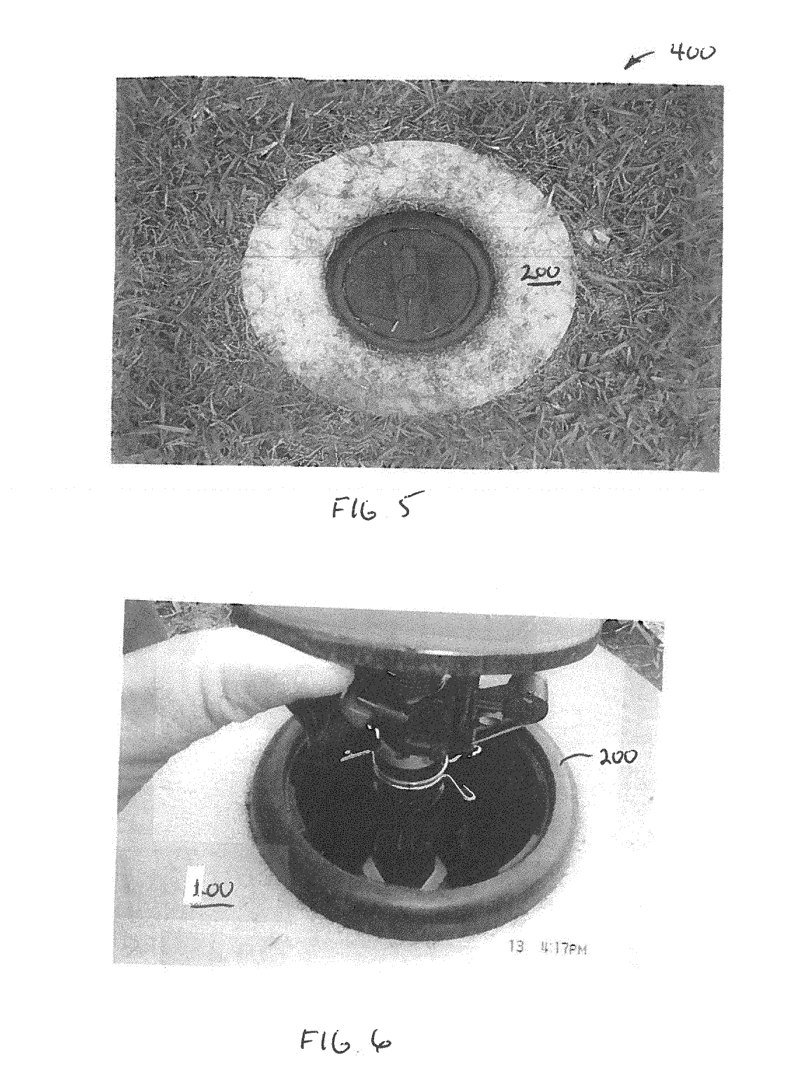

As seen in FIG. 4, the combination 400 is readily identified in case repair or maintenance is needed. Further, the ready identification makes it easy to not drive over the sprinkler head 200 with the wheel of a tractor lawn mower or to step on the sprinkler head when walking across the lawn, or the like.

FIG. 5 illustrates how the sprinkler head 200 of the combination 400 maintains its position and shape after mowing. Because of the fibrous nature of the presently preferred geotextile material, grass clippings or other debris such as sand or dirt are more likely to adhere to the top surface 102 of the sprinkler head protector 100 than to migrate into the inner workings of the sprinkler head 200. It will be recognized that the flexibility and elasticity that make the sprinkler head protector 100 easy to install, also makes it easy to remove for cleaning if desired. Thus, if desired, the sprinkler head protector 100 can be removed and sprayed off with a hose or the like to maintain a clean appearance and then readily reinstalled.

FIG. 6 shows how the sprinkler head protector 100 advantageously protects the internal components of the sprinkler head 200. Keeping the interior clean allows the sprinkler head 200 to continue to work properly and reduces the need for maintenance. Actual field testing has established the sprinkler head protector 100 will advantageously work as described above.

While sprinkler head protector 100 is shown in FIGS. 2-6 as white in color, it will be recognized that the presently preferred geotextile material may be dyed various colors and a presently preferred color is a green shade selected to blend in more closely with a surrounding lawn. Different shades may be employed to suit different lawn colors or as desired by the user.

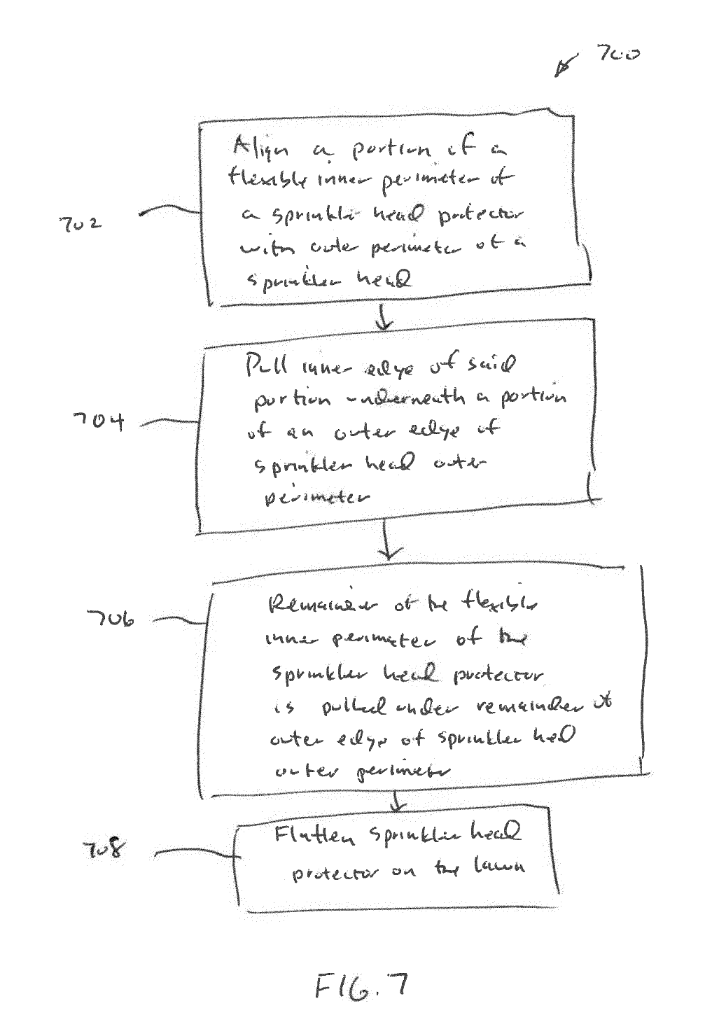

FIG. 7 shows a process 700 of protecting a sprinkler head having an outer perimeter and installed in a lawn. In step 702, a portion of a flexible inner perimeter of a similarly shaped cutout in a sprinkler head protector is aligned with said outer perimeter. In step 704, an inner edge of said portion is pulled underneath a portion of an outer edge of the outer perimeter of the sprinkler head. In step 706, a remainder of the flexible inner perimeter of the sprinkler head protector is pulled under a remainder of the outer edge of the outer perimeter of the sprinkler head trapping the inner edge of the sprinkler head beneath the outer edge of the outer perimeter of the sprinkler head. In step 708, the sprinkler head protector is flattened on the lawn.

To sum up, the sprinkler head protector 100 and process 700 control unwanted vegetation from growing over and above and into the sprinkler head 200. In addition to providing a physical barrier, it deprives any root system or plant beneath it of the sunlight needed to grow. As it is water permeable, it allows water and nutrients to filter through it. This arrangement will help to prevent erosion by keeping the root system alive. Upon removal of the sprinkler head protector 100, an intact root system may begin to refurbish the site.

Thus, the sprinkler head protector 100 provides weed control without using poisons or dangerous herbicides that might seep into the water system through normal runoff.

Constructed of durable ethylene terephthalate (PET), the presently preferred material is not to be confused with other landscape fabrics. It is so rugged and strong you can drive trucks or mowers safely over it. More specifically, needle-punched non-woven polyester fabric, polyethylene terephthalate (sometimes written poly(ethylene terephthalate)), commonly abbreviated PET or PETE is presently preferred. In the context of textile applications, PET is referred to by its common name, polyester, whereas the acronym PET is more commonly used in relation to packaging.

Unlike sod or grass, which needs to be retreated year after year, once the sprinkler head protector 100 is properly installed, it can be forgotten about for years to come. Yearly maintenance costs that typically rise with each new budget year can be reduced or eliminated.

The vegetation growth protection is the same as what a concrete pad would provide, yet the material conforms to the contour of the ground after a few short hours and then clings snugly to the ground.

A construction comprising a very dense, multi-directional needling of synthetic polyester fibers that is totally impregnated with a special resin that has ultraviolet inhibitors (100% UV protection) to safeguard against deterioration is presently preferred. The estimated life of such material is in excess of 15 years under normal conditions.

The sprinkler head protector 100 lays on the surface of the lawn around the sprinkler head protecting it from dirt and unwanted vegetation. Because sprinkler head protector 100 lies on the surface of the soil, it provides support to the sprinkler head 200, preventing it from leaning. The result is a far more stable sprinkler head that will require less maintenance and provide a consistent watering pattern for years to come.

Features of the presently preferred embodiment include the following:
prevents vegetation and soil/sand particles from damaging the sprinkler head
makes sprinkler heads easy to locate
cost effective
no herbicides or poison
made with 100% recycled materials
easy to install
no weed eaters required to trim back vegetation around the sprinkler head
environmentally safe and friendly
no disposal problems
reusable
resilient, conforms to shape
designed for abuse
prevents and controls erosion
long lasting over fifteen years
prevents alignment and watering pattern problems
reduces run-off
fire retardant
maintenance-free
controls unwanted vegetation
suit and protect all makes and models of sprinkler heads
100% UV protection

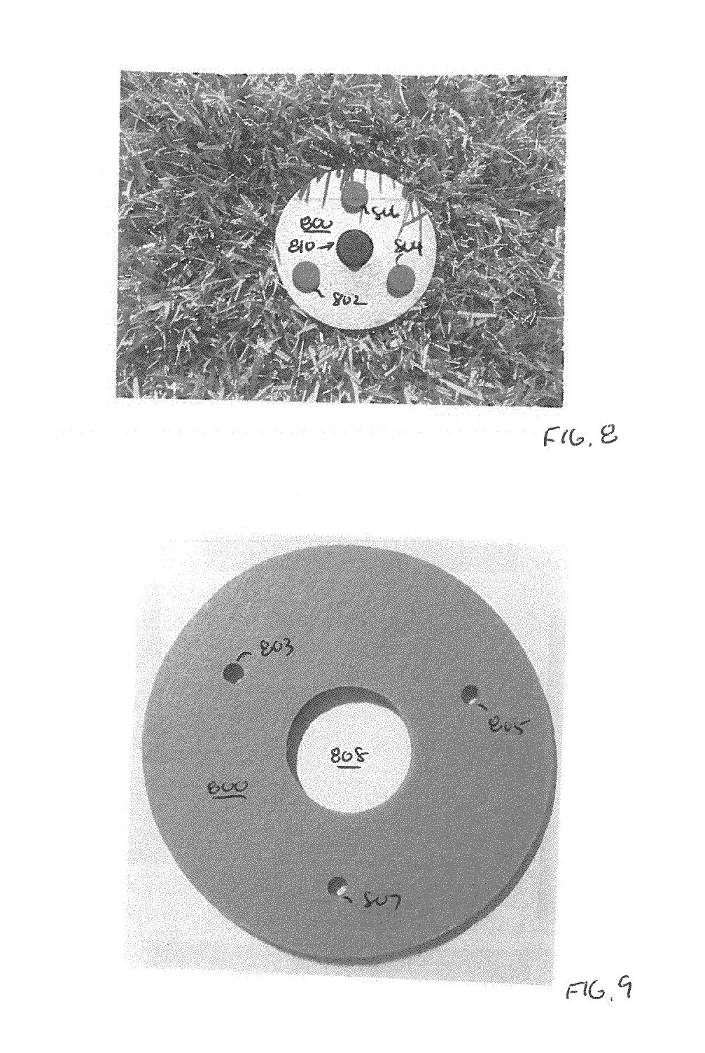

FIGS. 8 and 9 illustrate aspects of a second embodiment of the present invention in which a sprinkler head protector 800 slides over the top of a round sprinkler head 810 without stretching. To hold it in place, pegs 802, 804, 806 are driven down into the ground through holes 803, 805 and 807, respectively, shown in FIG. 9. For a sprinkler head with a circular outer perimeter of 1⅜, Center hole 808 is preferably 1⅜ inches in diameter. A presently preferred thickness for sprinkler head protector 800 is at least ¼ inch, and the outer diameter is 6 inches. Several different embodiments with varied dimensions may be adapted for various common sprinkler heads.

While the present invention has been disclosed in the context of various aspects of presently preferred embodiments, it will be recognized that the invention may be suitably applied to other environments consistent with the claims which follow. By way of example, the dimensions of the cutout and the outer diameter of the sprinkler head protector may be varied to suit the context of different sprinkler heads and outdoor environments in which they are employed.

I claim:

1. A sprinkler head protector comprising:
a flexible mat having a cutout smaller and shaped similarly to an outermost dimension of a corresponding sprinkler head; and
the flexible mat being sufficiently stretchable that it can be pulled by hand over the corresponding sprinkler head whereby an inner edge of the flexible mat is trapped under an outer edge of the corresponding sprinkler head.

2. The sprinkler head protector of claim 1 wherein said cutout is circular and has a first diameter and the corresponding sprinkler is circular and has a second diameter and the first diameter is less than the second diameter.

3. The sprinkler head protector of claim 2 wherein the first diameter is approximately 4⅜ inches and the second diameter is approximately 5 inches.

4. The sprinkler head protector of claim 2 wherein said flexible mat has an outer perimeter which is substantially circular.

5. The sprinkler head protector of claim 4 wherein said flexible mat has a thickness of at least ¼ inch.

6. The sprinkler head protector of claim 1 wherein said flexible mat is formed of a substantially fibrous material that is uniformly porous so as to block the passage of sunlight while being pervious to air and water, and is treated with an ultraviolet inhibitor and a flame retardant.

7. The sprinkler head protector of claim 1 wherein said flexible mat comprises a nonwoven geotextile material.

8. A method of protecting a sprinkler head having an outer perimeter and installed in a lawn, the method comprising:
aligning a portion of a flexible inner perimeter of a similarly shaped cutout in a sprinkler head protector;
pulling an inner edge of said portion underneath a portion of an outer edge of the outer perimeter of the sprinkler head;
pulling a remainder of the flexible inner perimeter of the sprinkler head protector under a remainder of the outer edge of the outer perimeter of the sprinkler head trapping the inner edge of the sprinkler head protector beneath the outer edge of the outer perimeter of the sprinkler head; and
flattening the sprinkler head protector on the lawn.

9. A sprinkler head protector and sprinkler head combination comprising: a sprinkler head having an outermost dimension;
a flexible mat having a cutout smaller and shaped similarly to the outermost dimension of the sprinkler head;
the flexible mat being sufficiently stretchable that it can be pulled by hand over the corresponding sprinkler head; and
the flexible mat having an inner edge trapped under an outer edge of the corresponding sprinkler head.

10. The sprinkler head protector and sprinkler head combination of claim 9 wherein said cutout is circular and has a first diameter and the corresponding sprinkler head is circular and has a second diameter, and the first diameter is less than the second diameter.

11. The sprinkler head protector and sprinkler head combination of claim 10 wherein the first diameter is approximately inches and the second diameter is approximately 5 inches.

12. The sprinkler head protector and sprinkler head combination of claim 10 wherein said flexible mat has an outer perimeter which is substantially circular.

13. The sprinkler head protector and sprinkler head combination of claim 12 wherein said flexible mat has a thickness of at least S inch.

14. The sprinkler head protector and sprinkler head combination of claim 9 wherein said flexible mat is formed of a substantially fibrous material that is uniformly porous so as to block the passage of sunlight while being pervious to air and water, and is treated with an ultraviolet inhibitor and a flame retardant.

15. The sprinkler head protector and sprinkler head combination of claim 9 wherein said flexible mat comprises a nonwoven geotextile material.

16. A sprinkler head protector comprising:
a flexible mat having a cutout shaped similarly to an outermost dimension of a corresponding sprinkler head and having retention holes;
the flexible mat placed over the corresponding sprinkler head; and a plurality of pegs staked through the retention holes.

17. The sprinkler head protector of claim 16 wherein said cutout is circular and has a first diameter and the corresponding sprinkler is circular and has a second diameter and the first diameter is substantially the same as the second diameter.

18. The sprinkler head protector of claim 17 wherein the first diameter is approximately 1⅜ inches.

19. The sprinkler head protector of claim 17 wherein said flexible mat has an outer perimeter which is substantially circular with a diameter of 6 inches.

20. The sprinkler head protector of claim 19 wherein said flexible mat has a thickness of at least ¼ inch.
